(19) United States
(12) Patent Application Publication
(10) Pub. No.: US 2010/0033385 A1
(43) Pub. Date: Feb. 11, 2010

(54) Multi-frequency antenna and electronic device having the multi-frequency antenna

(75) Inventors: Cheng-Wei Chang, Taipei Hsien (TW); Wei-Shan Chang, Taipei Hsien (TW)

Correspondence Address: BACON & THOMAS, PLLC, 625 SLATERS LANE, FOURTH FLOOR, ALEXANDRIA, VA, 22314-1176, US

(73) Assignee: WISTRON NEWEB CORP., Taipei Hsien (TW)

(21) Appl. No.: 12/453,462

(22) Filed: May 12, 2009

(30) Foreign Application Priority Data
Aug. 7, 2008 (TW) 097130091

(51) Int. Cl. H01Q 1/38; H01Q 1/24

(52) U.S. Cl. 343/702; 343/700 MS

(57) ABSTRACT

A multi-frequency antenna for wireless signal transmission of an electronic device is disclosed. The multi-frequency antenna has a radiating element, a grounding element, a feeding point, and a tuning bar. The radiating element comprises a first radiation area, a second radiation area, a third radiation area, and a fourth radiation area, wherein the third radiation area is perpendicularly connected to the second radiation area and the fourth radiation area substantially. The grounding element is used for grounding the multi-frequency antenna. The feeding point is disposed on the radiation area to feed an electric signal. The tuning bar is connected to the radiating element to adjust an operating band of the multi-frequency antenna.

### BACKGROUND OF THE INVENTION

1. Field of the Invention

The present invention relates to a multi-frequency antenna and, more particularly, to a multi-frequency antenna having a small volume and having a multi-frequency operating band controlled with a tuning bar.

2. Description of the Related Art

With developments in wireless communications technologies, many electronic devices in the market, such as notebook computers, have become lighter and smaller. In particular, users require not only the functionalities of the notebook computers; they also require the notebook computers to be lightweight and slim. Therefore, a traditional antenna cannot be disposed in the structural space of the notebook computers.

However, in wireless communications, the Wireless Wide Area Network (WWAN) antenna is a very popular and significant transmission device. In prior art technologies, the working frequency ranges of a WWAN antenna are usually 824˜960 MHz and 1710˜2170 MHz. However, these two bandwidths of the antenna do not satisfy current needs. New antennas should be able to have wider bandwidths to include such frequencies as global positioning system (GPS) frequencies of 1575 MHz.

In order to include different transmission frequency ranges, the prior art technology discloses an antenna for these portable electronic devices. Please refer to FIG. 1A. FIG. 1A is a schematic drawing of a prior art antenna 90 disclosed in U.S. Pat. No. 6,861,986. The prior art antenna 90 has a radiating element 91, a connecting element 92, and a grounding element 93. The connecting element 92 has a first end 921 and a second end 922; the first end 921 of the connecting element 92 is connected to the radiating element 91; and the second end 922 is connected to the grounding element 93.

Please refer to FIG. 1B. FIG. 1B shows the VSWR at different frequencies of the prior art antenna 90 shown in FIG. 1A. As shown in FIG. 1B, the working frequency ranges are only 2.5 GHz and 5 GHz, approximately. Therefore, the antenna 90 does not meet current bandwidth requirements of the WWAN antenna or other broadband antennas. In addition, in order to transmit an 800 MHz signal, the volume of the radiating element 91 of the antenna 90 must conform to the requirement of a quarter wavelength of the transmission signal. For that reason, the antenna 90 needs a large structural space. An electronic device must have a larger structural space to dispose antenna 90

Therefore, it is desirable to provide a multi-frequency antenna to mitigate and/or obviate the aforementioned problems.

### SUMMARY OF THE INVENTION

A main objective of the present invention is to provide a multi-frequency antenna having a small volume and having a multi-frequency operating band controlled with a tuning bar.

Another objective of the present invention is to provide an electronic device having the multi-frequency antenna.

In order to achieve the abovementioned objectives, the electronic device of the invention comprises a multi-frequency antenna and a wireless transmission module. The multi-frequency antenna electrically connects to the wireless transmission module. The multi-frequency antenna comprises a radiating element, a grounding element, a feeding point, and a tuning bar. The radiating element comprises a first radiation area, a second radiation area, a third radiation area, and a fourth radiation area, wherein the third radiation area is perpendicularly connected to the second radiation area and the fourth radiation area substantially. The grounding element is used for grounding the multi-frequency antenna. The feeding point is disposed on the first radiation area of the radiating element to feed an electric signal. The tuning bar is connected to the radiating element to adjust an operating band of the multi-frequency antenna

Other objects, advantages, and novel features of the invention will become more apparent from the following detailed description when taken in conjunction with the accompanying drawings.

### BRIEF DESCRIPTION OF THE DRAWINGS

FIG. 1A is a schematic drawing of an antenna of the prior art.

FIG. 1B shows the VSWR at different frequencies of the prior art antenna shown in FIG. 1A.

FIG. 2A is a perspective drawing of a multi-frequency antenna of a first embodiment according to the invention.

FIG. 2B is a front schematic drawing of a multi-frequency antenna of the first embodiment according to the invention.

FIG. 2C shows the VSWR at different frequencies of the first embodiment according to the invention shown in FIG. 2A.

FIG. 2D shows the efficiency at different frequencies of the first embodiment according to the invention shown in FIG. 2A.

FIG. 3 shows the VSWR of a multi-frequency antenna having tuning bars of different lengths.

FIG. 4A is a perspective drawing of a multi-frequency antenna of a second embodiment according to the invention.

FIG. 4B shows the VSWR at different frequencies of the second embodiment according to the invention shown in FIG. 4A.

FIG. 5A is a perspective drawing of a multi-frequency antenna of a third embodiment according to the invention.

FIG. 5B shows the VSWR at different frequencies of the third embodiment according to the invention shown in FIG. 5A.

FIG. 6A is a perspective drawing of a multi-frequency antenna of a fourth embodiment according to the invention.

FIG. 6B shows the VSWR at different frequencies of the fourth embodiment according to the invention shown in FIG. 6A.

FIG. 7A is a perspective drawing of a multi-frequency antenna of a fifth embodiment according to the invention.

FIG. 7B shows the VSWR at different frequencies of the fifth embodiment according to the invention shown in FIG. 7A.

FIG. 8A is a perspective drawing of a multi-frequency antenna of a sixth embodiment according to the invention.

FIG. 8B shows the VSWR at different frequencies of the sixth embodiment according to the invention shown in FIG. 8A.

FIG. 9A is a perspective drawing of a multi-frequency antenna of a seventh embodiment according to the invention.

FIG. 9B shows the VSWR at different frequencies of the seventh embodiment according to the invention shown in FIG. 9A.

FIG. 10A is a perspective drawing of a multi-frequency antenna of an eighth embodiment according to the invention.

FIG. 10B shows the VSWR at different frequencies of the eighth embodiment according to the invention shown in FIG. 10A.

FIG. 11A is a perspective drawing of a multi-frequency antenna of a ninth embodiment according to the invention.

FIG. 11B shows the VSWR at different frequencies of the ninth embodiment according to the invention shown in FIG. 11A.

FIG. 12A is a perspective drawing of a multi-frequency antenna of a tenth embodiment according to the invention.

FIG. 12B shows the VSWR at different frequencies of the tenth embodiment according to the invention shown in FIG. 12A.

FIG. 13 is a functional block drawing of an electronic device according to the invention.

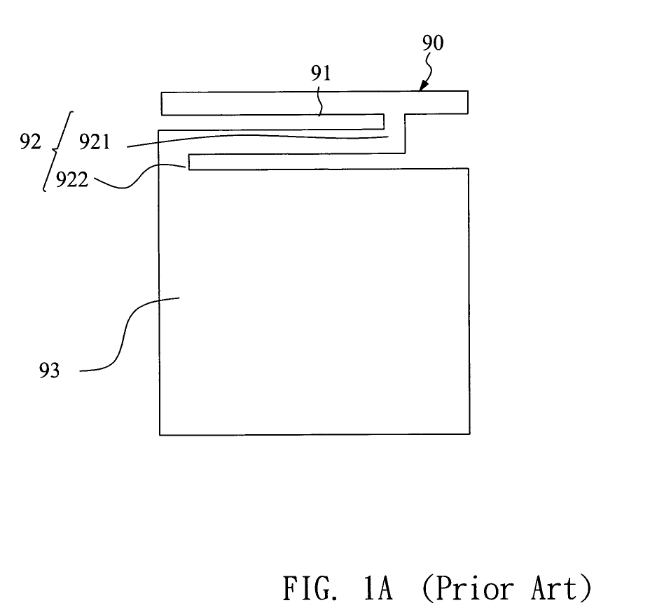

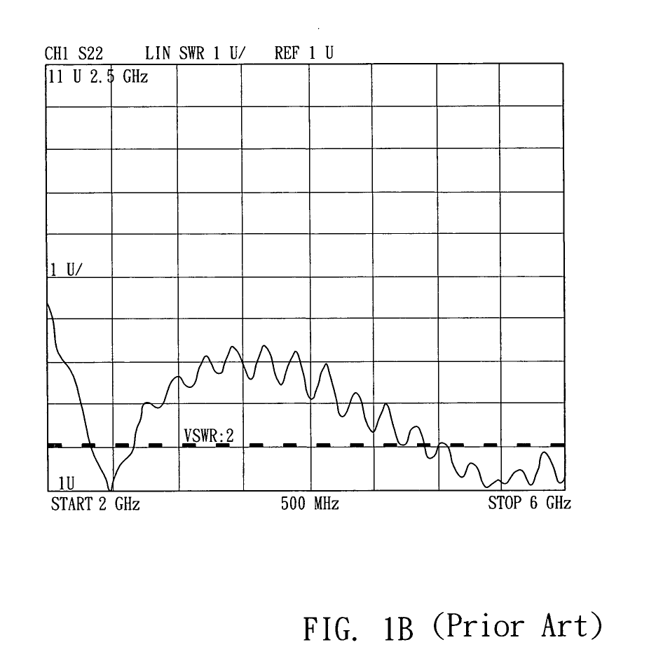

### DETAILED DESCRIPTION OF THE PREFERRED EMBODIMENT

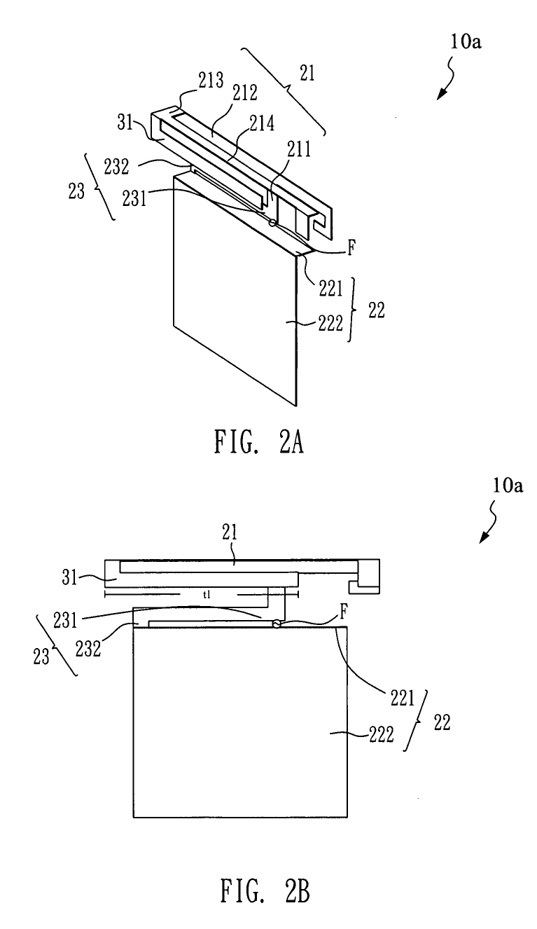

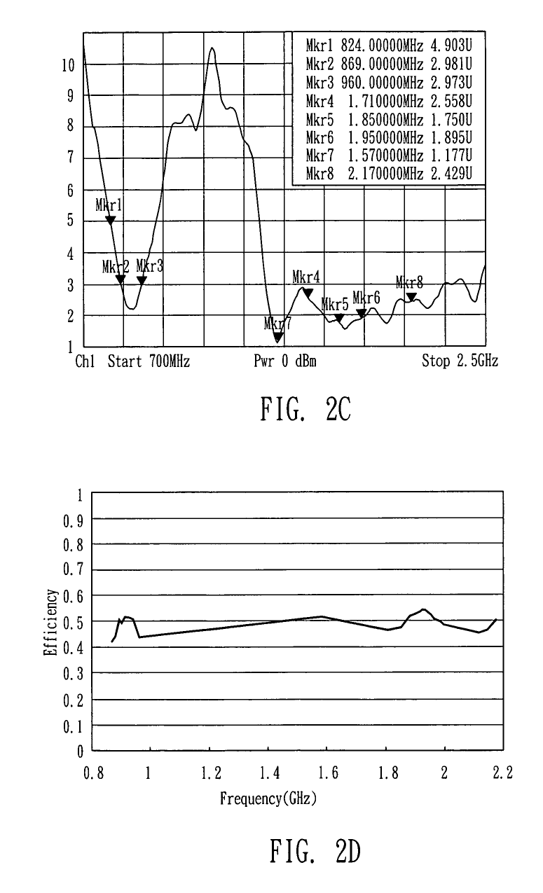

Please refer to FIG. 2A and FIG. 2B. FIG. 2A is a perspective drawing of a multi-frequency antenna of a first embodiment according to the invention. FIG. 2B is a front schematic drawing of a multi-frequency antenna of the first embodiment according to the invention.

In the first embodiment of the invention, the multi-frequency antenna 10a is a 3-D structure. The multi-frequency antenna 10a comprises a radiating element 21, a grounding element 22, a connecting element 23, a tuning bar 31, and a feeding point F. The radiating element 21 is composed of a metal. When current is fed into the radiating element 21, the radiating element 21 emits radiation energy. The radiating element 21 comprises a first radiation area 211, a second radiation area 212, a third radiation area 213, and a fourth radiation area 214. The first radiation area 211 is connected to the second radiation area 212. The third radiation area 213 is connected to the second radiation area 212 and the fourth radiation area 214. There are bends between the third radiation area 213 and the second radiation area 212, and between the third radiation area 213 and the fourth radiation area 214. The third radiation area 213, the second radiation area 212, and the fourth radiation area 214 are perpendicularly connected to each other substantially. The sum of the lengths of the areas of the radiating element 21 aforementioned satisfies the requirement of a quarter wavelength of the transmission signal.

The grounding element 22 is also composed of a metal and is used for grounding the multi-frequency antenna 10a. The grounding element 22 comprises a first plane 221 and a second plane 222. There is a bend between the first plane 221 and the second plane 222. The first plane 221 and the second plane 222 are perpendicularly connected to each other substantially. The connecting element 23 comprises a first end 231 and a second end 232. The first end 231 of the connecting element 23 is connected to the first radiation area 211 of the radiating element 21, and the second end 232 of the connecting element 23 is perpendicularly connected to the first plane 221 of the grounding element 22 substantially.

In this embodiment, the tuning bar 31 is an L-shaped metal bar. The tuning bar 31 is extended from the fourth radiation area 214 and perpendicularly connected to the fourth radiation area 214 substantially. The tuning bar 31 can also be an extension area of the radiating element 21. The multi-frequency antenna 10a adjusts the operating band with the tuning bar 31.

The first radiation area 211 of the radiating element 21 further comprises a feeding point F. The feeding point F and a feeding line (not shown) are electrically connected to each other and used for transmitting an electrical signal. The feeding line can be an RF cable or other transmission line types.

With the connection relationship of the all elements aforementioned, the multi-frequency antenna 10a becomes a 3-D structure. The multi-frequency antenna 10a can decrease the height from the radiating element 21 to the grounding element 22 to reduce the volume of the multi-frequency antenna 10a. Therefore, the multi-frequency antenna 10a can be disposed in an electronic device with a small structural space.

Please refer to FIG. 2C. FIG. 2C shows the VSWR at different frequencies of the first embodiment according to the invention shown in FIG. 2A. As shown in FIG. 2C, the multi-frequency antenna 10a has 900 MHz and 1575 MHz operating bands. Therefore, the broadband antenna 10a is capable of meeting the requirements of multiple operating bands, such as the operating bands of the global positioning system and the global system for mobile communication, wherein the operating band of the global positioning system is 1575 MHz, and the operating band of the global system for mobile communication is 880 MHz to 960 MHz.

Please refer to FIG. 2D. FIG. 2D shows the efficiency at different frequencies of the first embodiment according to the invention shown in FIG. 2A. As shown in FIG. 2D, the transmission efficiency of the multi-frequency antenna 10a at frequencies of 900 MHz and 1575 MHz can be greater than 42%. Therefore, the multi-frequency antenna 10a has obviously superior transmission efficiency.

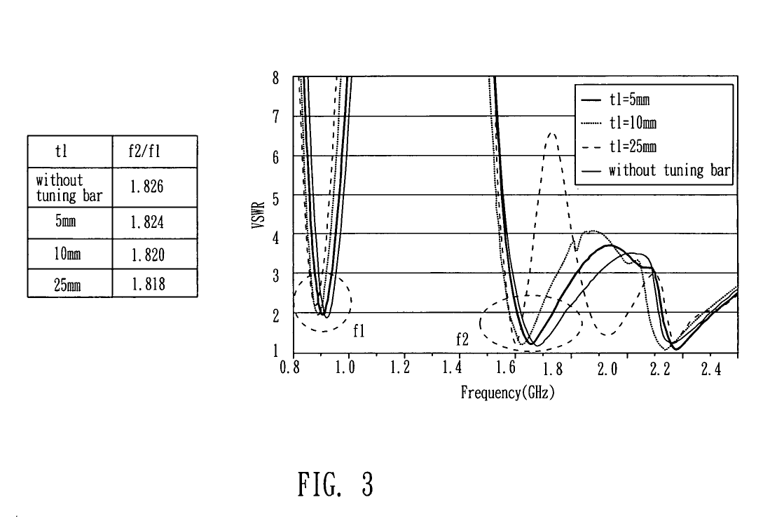

In addition, the length t1 of the tuning bar 31 (as shown in 2B) can be adjusted according to requirements. Please refer to FIG. 3, which shows the VSWR of a multi-frequency antenna having tuning bars of different lengths.

As shown in FIG. 3, if the multi-frequency antenna 10a does not have the tuning bar 31, the ratio of the first frequency band f1 to the second frequency band f2 is 1.826. When the length of the tuning bar 31 is 5 mm, the ratio of the first frequency band f1 to the second frequency band f2 is 1.824. When the length of the tuning bar 31 is 10 mm, the ratio of the first frequency band f1 to the second frequency band f2 is 1.820. When the length of the tuning bar 31 is 25 mm, the ratio of the first frequency band f1 to the second frequency band f2 is 1.818. Therefore, the invention can have different frequency ratios according to the different lengths of the tuning bar 31 to adjust to a required frequency band.

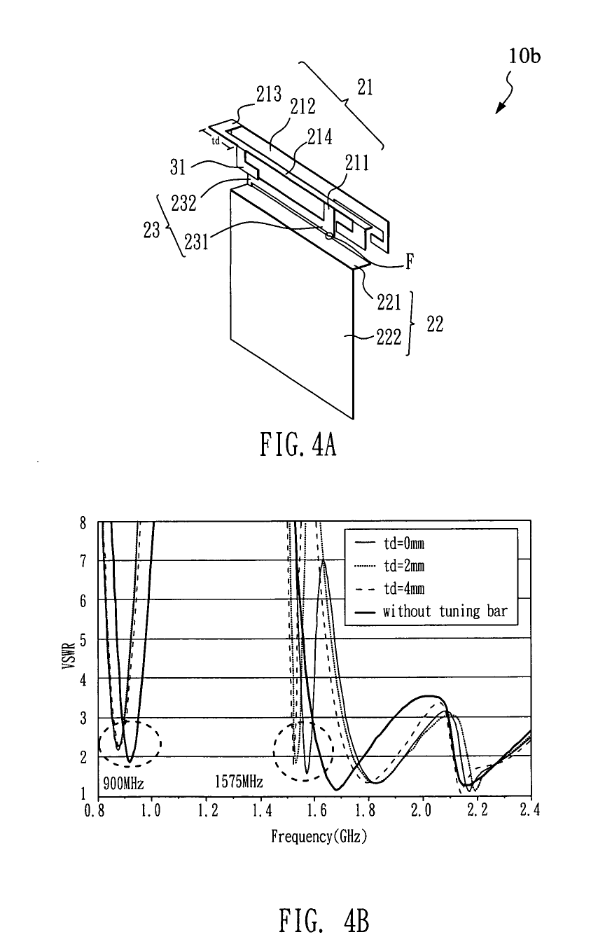

Please refer to FIG. 4A and FIG. 4B. FIG. 4A is a perspective drawing of a multi-frequency antenna of a second embodiment according to the invention. FIG. 4B shows the VSWR at different frequencies of the second embodiment according to the invention shown in FIG. 4A.

In the second embodiment of the invention, the distance from the connected position between the tuning bar 31 of the multi-frequency antenna 10b and the fourth radiation area 214 to the side of the radiating element 21 is a specific distance td. As shown in FIG. 4B, when distance td is 0 mm, 2 mm, or 4 mm, the multi-frequency antenna 10b has different operating bands. Therefore, the operating band of the multi-frequency antenna 10b can be adjusted by changing the position of the tuning bar 31.

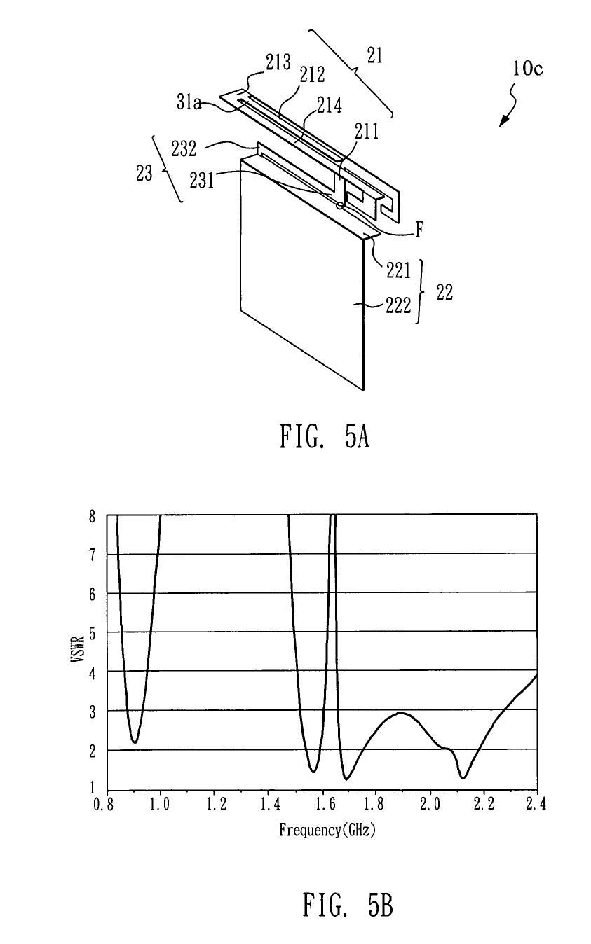

The connected position between the tuning bar 31 and the radiating element 21 of the invention is not limited to the first and second embodiments. Please refer to FIG. 5A and FIG. 5B. FIG. 5A is a perspective drawing of a multi-frequency antenna of a third embodiment according to the invention. FIG. 5B shows the VSWR at different frequencies of the third embodiment according to the invention shown in FIG. 5A.

In the third embodiment of the invention, the tuning bar 31a of the multi-frequency antenna 10c is disposed between the second radiation area 212 and the fourth radiation area 214 and connected to the third radiation area 213. As shown in FIG. 5B, the multi-frequency antenna 10c is capable of resonating a frequency band of about 1500 MHz.

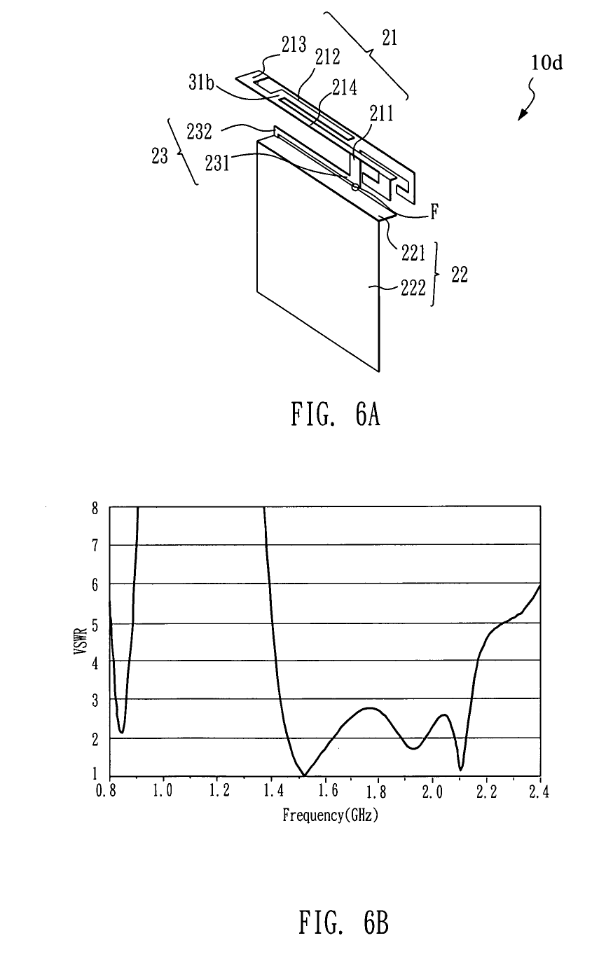

Please refer to FIG. 6A and FIG. 6B. FIG. 6A is a perspective drawing of a multi-frequency antenna of a fourth embodiment according to the invention. FIG. 6B shows the VSWR at different frequencies of the fourth embodiment according to the invention shown in FIG. 6A.

In the fourth embodiment of the invention, the tuning bar 31b of the multi-frequency antenna 10d is disposed between the second radiation area 212 and the fourth radiation area 214 and is perpendicularly connected to the fourth radiation area 214 substantially. As shown in FIG. 6B, the multi-frequency antenna 10d also is capable of resonating a frequency band of about 1500 MHz.

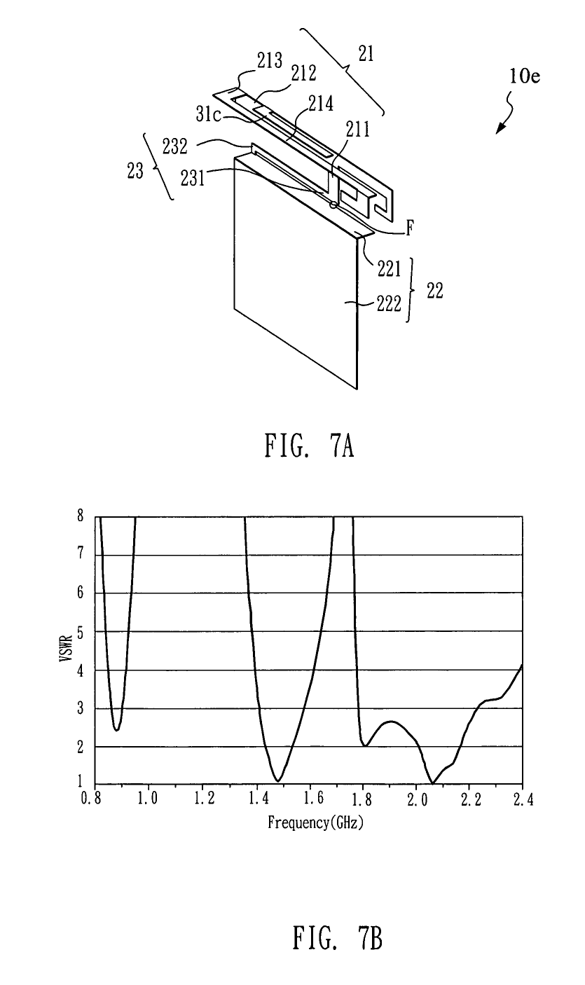

Please refer to FIG. 7A and FIG. 7B. FIG. 7A is a perspective drawing of a multi-frequency antenna of a fifth embodiment according to the invention. FIG. 7B shows the VSWR at different frequencies of the fifth embodiment according to the invention shown in FIG. 7A.

In the fifth embodiment of the invention, the tuning bar 31c of the multi-frequency antenna 10e is disposed between the second radiation area 212 and the fourth radiation area 214 and is perpendicularly connected to the second radiation area 212 substantially. As shown in FIG. 7B, the multi-frequency antenna 10e also is capable of resonating a frequency band of about 1500 MHz.

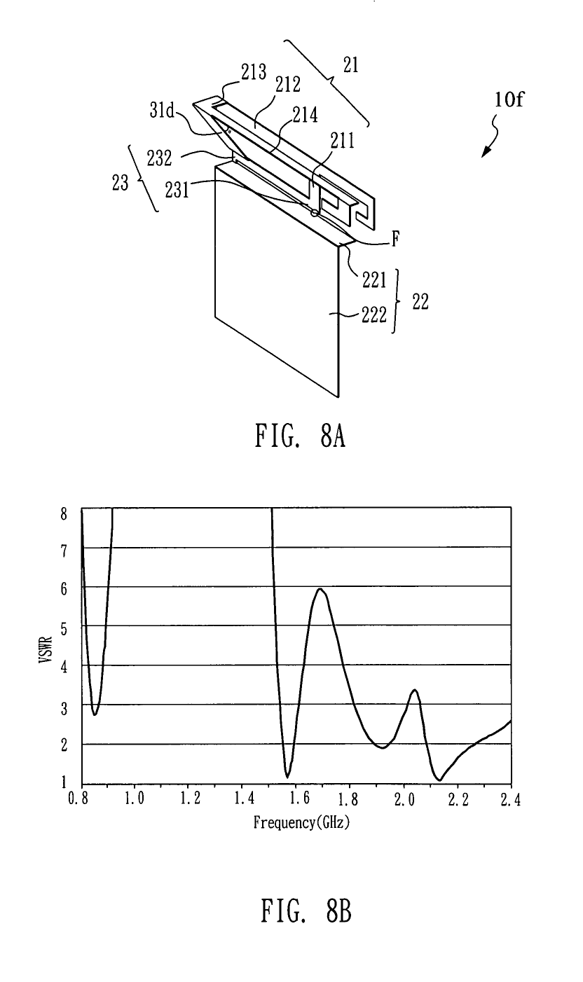

Please refer to FIG. 8A and FIG. 8B. FIG. 8A is a perspective drawing of a multi-frequency antenna of a sixth embodiment according to the invention. FIG. 8B shows the VSWR at different frequencies of the sixth embodiment according to the invention shown in FIG. 8A.

In the sixth embodiment of the invention, the included angle between the tuning bar 31d of the multi-frequency antenna 10f and the fourth radiation area 214 of the radiating element 21 has a specific angle θ. The specific angle θ is not limited to 90° (as shown in 2A). In the sixth embodiment of the invention, the specific angle θ is less than 90°. As shown in FIG. 8B, the multi-frequency antenna 10f also is capable of resonating a frequency band of about 1600 MHz.

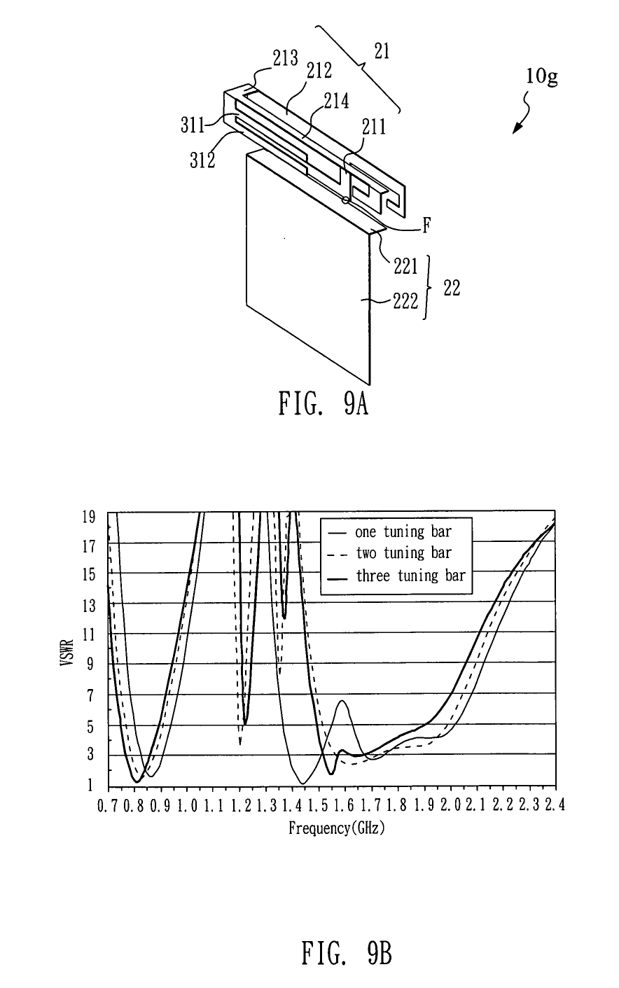

The tuning bar 31 of the invention is not limited to a single metal. Please refer to FIG. 9A and FIG. 9B. FIG. 9A is a perspective drawing of a multi-frequency antenna of a seventh embodiment according to the invention. FIG. 9B shows the VSWR at different frequencies of the seventh embodiment according to the invention shown in FIG. 9A.

As shown in FIG. 9A, the multi-frequency antenna 10g of the seventh embodiment of the invention has a first tuning bar 311 and a second tuning bar 312. The first tuning bar 311 and the second tuning bar 312 are L-shaped metal bars and are connected to each other. As shown in FIG. 9B, when the multi-frequency antenna 10g has an additional one tuning bar, the multi-frequency antenna 10g has another operating band. Therefore, the multi-frequency antenna 10g is capable of resonating different frequency bands due to the multiple tuning bars.

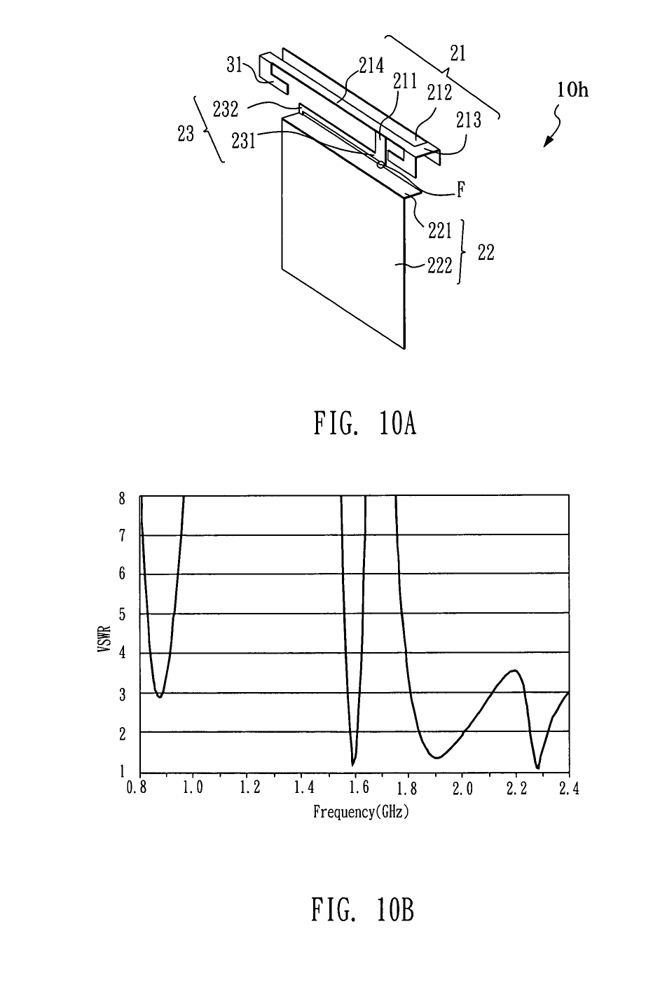

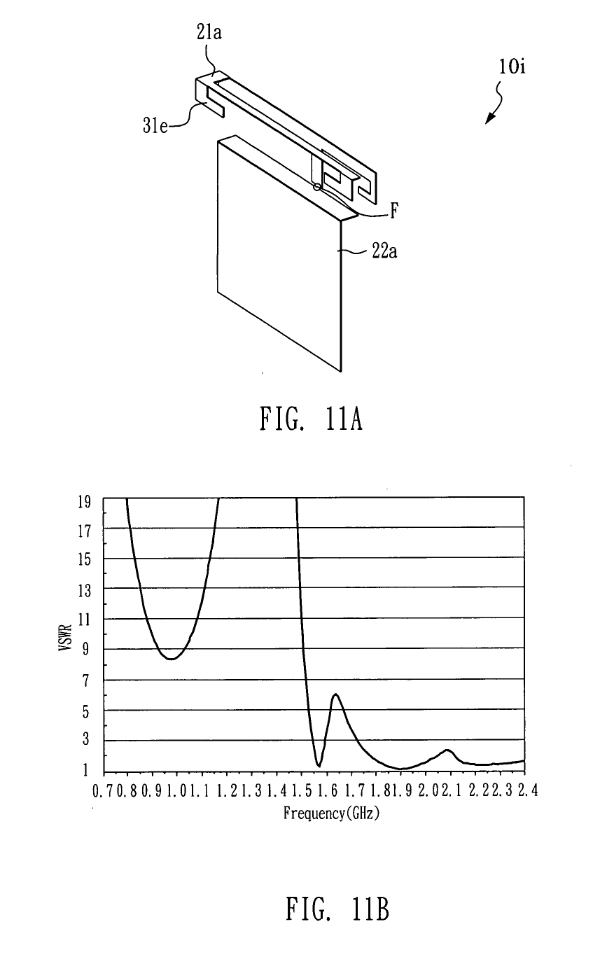

Please refer to FIG. 10A and FIG. 10B. FIG. 10A is a perspective drawing of a multi-frequency antenna of an eighth embodiment according to the invention. FIG. 10B shows the VSWR at different frequencies of the eighth embodiment according to the invention shown in FIG. 10A.

In the eighth embodiment of the invention, the third radiation area 213 of the multi-frequency antenna 10h is in the opposite direction of that of the third radiation area 213 of the multi-frequency antenna 10a. As shown in FIG. 10B, the multi-frequency antenna 10h is also capable of multi-frequency transmission.

Please refer to FIG. 11A and FIG. 11B. FIG. 11A is a perspective drawing of a multi-frequency antenna of a ninth embodiment according to the invention. FIG. 11B shows the VSWR at different frequencies of the ninth embodiment according to the invention shown in FIG. 11A.

In the ninth embodiment of the invention, the multi-frequency antenna 10i is a monopole antenna. The multi-frequency antenna 10i comprises a radiating element 21a, a grounding element 22a, and a tuning bar 31e. The radiating element 21a of the multi-frequency antenna 10i is bent into a 3-D structure. In contrast to the multi-frequency antenna 10a in the first embodiment, the multi-frequency antenna 10i does not have the connecting element 23. As shown in FIG. 11B, the multi-frequency antenna 10i is also capable of multi-frequency transmission.

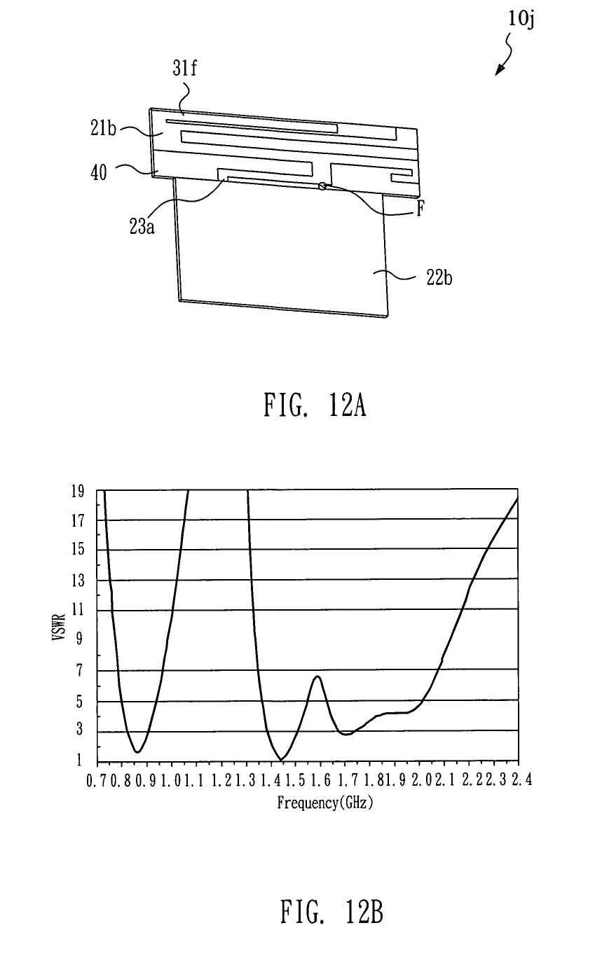

Please refer to FIG. 12A and FIG. 12B. FIG. 12A is a perspective drawing of a multi-frequency antenna of a tenth embodiment according to the invention. FIG. 12B shows the VSWR at different frequencies of the tenth embodiment according to the invention shown in FIG. 12A.

In the tenth embodiment of the invention, the multi-frequency antenna 10j is a planar antenna. The multi-frequency antenna 10j comprises a radiating element 21b, a grounding element 22b, a connecting element 23a, a tuning bar 31f, and a base board 40. The base board 40 is a printed circuit board, a plastic board, or a fiberglass board. The radiating element 21b, the connecting element 23a, and the tuning bar 31f are connected to each other and printed on the base board 40. The grounding element 22b is connected to the connecting element 23a. As shown in FIG. 12B, when the multi-frequency antenna 10j is a planar antenna, the multi-frequency antenna 10j is also capable of multi-frequency transmission. In contrast to the prior art antenna 90, the multi-frequency antenna 10j is smaller in volume.

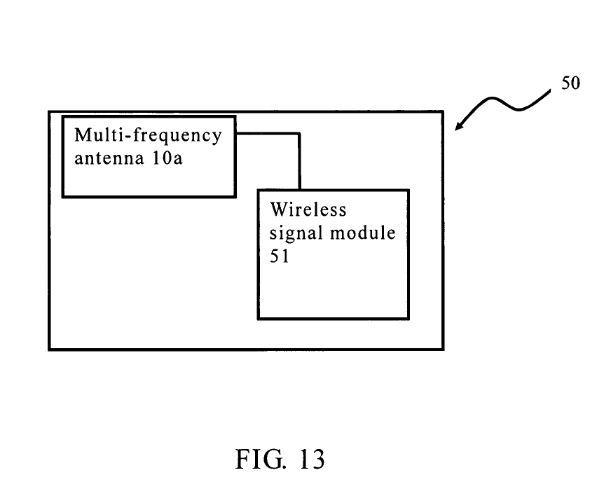

Please refer to FIG. 13. FIG. 13 is a functional block drawing of an electronic device of the invention.

In one embodiment of the invention, an electronic device 50 can be a notebook computer, a GPS, or any other portable device with a small structural space. As shown in FIG. 13, the electronic device 50 comprises the multi-frequency antenna 10a and a wireless signal module 51. The electronic device 50 uses RF cables to provide a feed to the multi-frequency antenna 10a and is connected to a wireless signal module 51, which processes signals from the multi-frequency antenna 10a such as transmitted or received signals. The electronic device 50 can thus use the multi-frequency antenna 10a to transmit or receive wireless signals to or from other devices (not shown).

In addition, the electronic device 50 is not limited to comprise the multi-frequency antenna 10a. Any antenna of the multi-frequency antenna 10b to the multi-frequency antenna 10j can substituted for the multi-frequency antenna 10a to transmit or receive wireless signals.

Although the present invention has been explained in relation to its preferred embodiment, it is to be understood that many other possible modifications and variations can be made without departing from the spirit and scope of the invention as hereinafter claimed.

What is claimed is:

1. A multi-frequency antenna comprising:
a radiating element comprising a first radiation area, a second radiation area, a third radiation area, and a fourth radiation area, wherein the third radiation area is perpendicularly connected to the second radiation area and the fourth radiation area substantially;
a grounding element, used for grounding the multi-frequency antenna;
a feeding point disposed on the first radiation area of the radiating element to feed an electric signal; and
a tuning bar connected to the radiating element to adjust an operating band of the multi-frequency antenna.

2. The multi-frequency antenna as claimed in claim 1, wherein the grounding element further comprises a first plane and a second plane;
the first plane is perpendicularly connected to the second plane substantially.

3. The multi-frequency antenna as claimed in claim 2, the multi-frequency antenna further comprising a connecting element having a first end and a second end; the first end is connected to the radiating element and the second end is connected to the grounding element.

4. The multi-frequency antenna as claimed in claim 1, wherein the antenna body is a 3-D structure.

5. The multi-frequency antenna as claimed in claim 1, wherein the antenna body is a platform structure.

6. The multi-frequency antenna as claimed in claim 5 further comprising a base board, on which the radiating element and the tuning bar are printed.

7. The multi-frequency antenna as claimed in claim 1, wherein the tuning bar is connected to the second radiation area, the third radiation area, or the fourth radiation area.

8. The multi-frequency antenna as claimed in claim 1, wherein the tuning bar and the fourth radiation area of the radiating element are sloped at a specific angle.

9. An electronic device having a multi-frequency antenna and capable of wireless transmissions comprising:
a wireless signal module; and
a multi-frequency antenna electrically connected to the wireless signal module, the multi-frequency antenna comprising:
a radiating element comprising a first radiation area, a second radiation area, a third radiation area, and a fourth radiation area, wherein the third radiation area is perpendicularly connected to the second radiation area and the fourth radiation area substantially;
a grounding element, used for grounding the multi-frequency antenna;
a feeding point disposed on the first radiation area of the radiating element to feed an electric signal; and
a tuning bar connected to the radiating element to adjust an operating band of the multi-frequency antenna.

10. The electronic device having the multi-frequency antenna as claimed in claim 9, wherein the grounding element further comprises a first plane and a second plane; the first plane is perpendicularly connected to the second plane substantially.

11. The electronic device having the multi-frequency antenna as claimed in claim 10, wherein the multi-frequency antenna further comprises a connecting element having a first end and a second end; the first end is connected to the radiating element and the second end is connected to the grounding element.

12. The electronic device having the multi-frequency antenna as claimed in claim 9, wherein the antenna body is a 3-D structure.

13. The electronic device having the multi-frequency antenna as claimed in claim 9, wherein the antenna body is a platform structure.

14. The electronic device having the multi-frequency antenna as claimed in claim 13, wherein the multi-frequency antenna further comprises a base board, on which the radiating element and the tuning bar are printed.

15. The electronic device having the multi-frequency antenna as claimed in claim 9, wherein the tuning bar is connected to the second radiation area, the third radiation area, or the fourth radiation area.

16. The electronic device having the multi-frequency antenna as claimed in claim 9, wherein the tuning bar and the fourth radiation area of the radiating element are sloped at a specific angle
